(19) United States
(12) Patent Application Publication
(10) Pub. No.: US 2024/0149185 A1
(43) Pub. Date: May 9, 2024

(54) BUILDING BLOCK ASSEMBLY

(71) Applicant: CHARLIE-KAO INDUSTRY CO., LTD., NEW TAIPEI CITY (TW)

(72) Inventor: TSENG-CHI KAO, NEW TAIPEI CITY (TW)

(21) Appl. No.: 17/980,563

(22) Filed: Nov. 4, 2022

(51) Int. Cl. A63H 33/14; C08L 23/22

(52) U.S. Cl. CPC A63H 33/14; C08L 23/22

(57) ABSTRACT

There is provided a building block assembly including a block body formed of EVA; and an adhesive layer adhered to the block body and formed of hydrophobic material having a higher viscosity. The adhesive layer comprises 20 wt %-50 wt % of rubber mixture and 50 wt %-80 wt % of high polymer resin mixed together. The rubber mixture comprises rubber, softening agent and filler. The high polymer resin uses PIB having a heavy molecular weight. There is further provided a building block assembly including a block body formed of soft material; and an adhesive layer adhered to the block body and formed of hydrophobic material having a higher viscosity. The adhesive layer comprises 20 wt %-50 wt % of rubber mixture and 50 wt %-80 wt % of high polymer resin mixed together. The rubber mixture comprises rubber, softening agent and filler. The high polymer resin uses PIB having a heavy molecular weight.

### FIELD OF THE INVENTION

The invention relates to building blocks and more particularly to a building block assembly comprising a block body and an adhesive layer adhered to the block body and formed of hydrophobic material having a higher viscosity. A toy having the properties of building block and clay is generated by means of the building block assembly.

### BACKGROUND OF THE INVENTION

A variety of clay toys have been developed since the 20th century. Some of these clay toys were invented by their clay properties. Some of which are water-based, oil-based, non-drying, quick-drying, heavy, light, jumping, transparent. Some clay toys are invented by their appearance. Some of which are transparent, temperature-changing, luminous, and fluorescent colors. There are also some clay toys that are not clay themselves, but need to be made by the hands to form clay. Even some clay toys are just a concept. They do not look like clay, but they have the characteristics of being moldable by clay. There are also some clay toys. It was invented by incorporating the concept of some daily necessities.

Nowadays, the market of building block toys has reached its limit. Most building block toys are composed of a convex surface and a groove surface. Only a small number of building block toys do not have any tenons. These blocks not having any tenons are made of water-based resin. Water is used to make the resin surface sticky and the building blocks are glued together. This is a special way to play, but it has an obvious disadvantage, that is, it is difficult to separate after drying. The structure of the resin has been destroyed after being wetted with water so that the effect of repeated watering is not better than the first watering. Thus, it does not have the reusable characteristics of building blocks, and it is also glued to the building blocks with double-sided tape. It is possible of making a building block toy without any tenons, but it is also the same problem as the building blocks composed of water-based resin. After the two building blocks are glued together, it is difficult to separate them, and there is no way to reuse them. Another non-tenon building block toy uses magnets to connect two building blocks together. This kind of building blocks made of magnets is not easy to break and can be reused. It fully conforms to the characteristics and value of building blocks, but the manufacturing cost is high, and the volume is not easy to control at will so that the price is often higher. Another method is to coat the surface of the two building blocks with liquid resin. After drying, the two building blocks will be fastened by the resin. The force generated between the two blocks sticks them together, and because the force is not strong, the blocks can be disassembled and re-bonded, but because of this, the blocks will be separated soon after they are bonded, which is a great disadvantage for a building block toy. Therefore, although the market of building block toys is very saturated, the building blocks without any tenons are not popular in all aspects, and there are many defects so that there is no breakthrough in all aspects.

The direct use of high viscosity polymers has been very mature in many fields. The most commonly used field is the adhesive part. Others are related to biology and medical treatment, but only a few parts are applied. For chemical toys, due to age restrictions, chemical toys rarely use high viscosity polymers directly to make toys. Most of them are clay toys, and most of them are water-based, high viscosity molecules. Hydrophobic and highly viscous polymers are very few. Not only that, environmental protection awareness has become higher and higher in recent years. There are many restrictions, and it is difficult to make other breakthroughs, so that this has always been a very challenging field

Thus, the need for improvement still exists.

### SUMMARY OF THE INVENTION

It is therefore a first object of the invention to provide a building block assembly comprising a block body and an adhesive layer adhered to the block body and formed of hydrophobic material having a higher viscosity.

It is a second object of the invention to provide a building block assembly which forms a building block without tenon. A high viscosity, high polymer block body is used on a building block. Next, size of ethylene vinyl acetate (EVA) block body is changed. As a result, a toy having the properties of building block and clay is generated.

It is a third object of the invention to provide a building block assembly which can be squeezed, pressed, assembled, adhered so that a kid has a great fun by working on it.

It is a fourth object of the invention to provide a building block assembly which can have any color or be colorful. The building block assembly can be any shape such as cube, parallelepiped, circle, or triangle. Length, width and height of the building block assembly can any sizes.

For achieving above and other objects, there is provided a building block assembly comprising a block body formed of ethylene vinyl acetate (EVA); and an adhesive layer adhered to the block body and formed of hydrophobic material having a higher viscosity wherein the adhesive layer comprises 20 wt %-50 wt % of rubber mixture and 50 wt %-80 wt % of high polymer resin mixed together; wherein the rubber mixture comprises rubber, softening agent and filler; and wherein the high polymer resin uses polyisobutylene (PIB) having a heavy molecular weight.

Preferably, the rubber has 30 wt %-50 wt % of butyl rubber; the softening agent has 15 wt %-40 wt % of polybutene (PB) having a light molecular weight; and the filler has 30 wt %-50 wt % of the rubber mixture; and silicon dioxide (SiO₂), aluminium hydroxide (Al(OH)₃), calcium carbonate (CaCO₃), or a combination thereof is selected as the filler.

For achieving above and other objects, there is further provided a building block assembly comprising a block body formed of soft material; and an adhesive layer adhered to the block body and formed of hydrophobic material having a higher viscosity wherein the adhesive layer comprises 20 wt %-50 wt % of rubber mixture and 50 wt %-80 wt % of high polymer resin mixed together; wherein the rubber mixture comprises rubber, softening agent and filler; and wherein the high polymer resin uses polyisobutylene (PIB) having a heavy molecular weight.

Preferably, the rubber has 30 wt %-50 wt % of butyl rubber; the softening agent has 15 wt %-40 wt % of polybutene (PB) having a light molecular weight; and the filler has 30 wt %-50 wt % of the rubber mixture; and silicon dioxide (SiO₂), aluminium hydroxide (Al(OH)₃), calcium carbonate (CaCO₃), or a combination thereof is selected as the filler.

The above and other objects, features and advantages of the invention will become apparent from the following detailed description taken with the accompanying drawings

### BRIEF DESCRIPTION OF THE DRAWINGS

FIG. 1 is a sectional view of a building block assembly of the invention; and

FIG. 2 is a detailed view of the area in circle A of FIG. 1.

### DETAILED DESCRIPTION OF THE INVENTION

The invention provides a building block assembly which forms a building block without tenon. A high viscosity, high polymer block body is used on a building block. Next, size of ethylene vinyl acetate (EVA) block body is changed. As a result, a toy having the properties of building block and clay is generated.

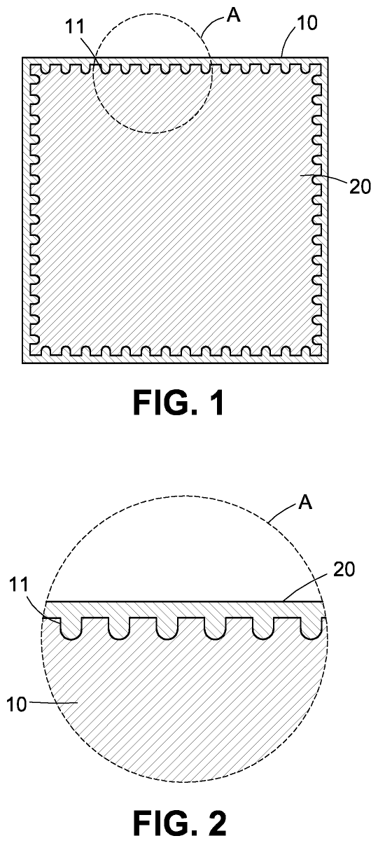

Referring to FIGS. 1 to 2, a building block assembly according to a first embodiment of the invention comprises a block body 10 formed of EVA, and an adhesive layer 20 adhered to the block body 10 and formed of hydrophobic material having a higher viscosity. The adhesive layer 20 comprises 20 wt %-50 wt % of rubber mixture and 50 wt %-80 wt % of high polymer resin mixed together. The rubber mixture comprises rubber, softening agent and filler. The high polymer resin uses polyisobutylene (PIB) having a heavy molecular weight.

In the first embodiment of the building block assembly, the rubber has 30 wt %-50 wt % of butyl rubber; the softening agent has 15 wt %-40 wt % of polybutene (PB) having a light molecular weight; and the filler has 30 wt %-50 wt % of the rubber mixture. Silicon dioxide (SiO₂), aluminium hydroxide (Al(OH)₃), calcium carbonate (CaCO₃), or a combination thereof is selected as the filler.

Referring to FIGS. 1 to 2, a building block assembly according to a second embodiment of the invention comprises a block body 10 formed of soft material and an adhesive layer 20 adhered to the block body 10 and formed of hydrophobic material having a higher viscosity. The adhesive layer 20 comprises 20 wt %-50 wt % of rubber mixture and 50 wt %-80 wt % of high polymer resin mixed together. The rubber mixture comprises rubber, softening agent and filler. The high polymer resin uses polyisobutylene (PIB) having a heavy molecular weight.

In the second embodiment of the building block assembly, the rubber has 30 wt %-50 wt % of butyl rubber; the softening agent has 15 wt %-40 wt % of polybutene (PB) having a light molecular weight; and the filler has 30 wt %-50 wt % of the rubber mixture. Silicon dioxide (SiO₂), aluminium hydroxide (Al(OH)₃), calcium carbonate (CaCO₃), or a combination thereof is selected as the filler.

The adhesive layer 20 is formed by mixing the rubber mixture and the high polymer resin. The rubber mixture comprises the following compositions: rubber such as (isobutylene isoprene rubber (IIR)) which is a synthetic rubber comprising a copolymer of isobutylene and small amount of isoprene; softening agent such as polybutylene (PB) having a light molecular weight; and filter such as silicon dioxide (Si_{O2}), aluminium hydroxide (Al(OH)₃) or calcium carbonate (CaC_{O3}).

Butyl rubber is the main composition of the viscous adhesive layer 20 having a heavy molecular weight. Butyl rubber has excellent chemical property and high resistance to heat. Butyl rubber is gas-proof and waterproof. Polybutene having a light molecular weight is add to butyl rubber for softening purpose because rubber of butyl rubber is not subject to work. Viscosity of rubber is increased due to the addition of softening agent. For overcoming the viscosity problem, filler is further added. As a result, viscosity of rubber is decreased to a degree that it is not sticky to the hand. The rubber mixture comprises 30 wt %-50 wt % of rubber, 15 wt %-40 wt % of softening agent, and 30 wt %-50 wt % of filler and the above compositions are mixed at 80° C.

The used high polymer resin is polyisobutylene (PIB) having a heavy molecular weight. It is saturated, linear high polymer and is hydrophobic. Thus, different rubbers such as styrene butadiene rubber (SBR) or natural rubber can be mixed with PIB to increase its resistance to aging and weathering. Viscosity of material is increased due to the addition of PIB. The invention utilizes this feature to mix 50 wt %-80 wt % of PIB and 20 wt %-50 wt % of butyl rubber together. It is found that they are compatible. Surface viscosity, tensile strength and breakage strength of butyl rubber mixture is greatly increased. This is because both butyl rubber and PIB have the feature of isobutylene. There is a strong action between them. High polymer links can be easily entangled (i.e., not being easy to separate). This explain a high compatibility between them to form a stable high polymer mixture.

The block body 10 is formed of EVA which has excellent softness and flexibility similar to rubber. Also, it has a stable chemical property; high resistance to ageing; and high resistance to ozone. EVA is toxic free and has wide applications in which one of the applications is used as a material for manufacturing shoe sole.

The invention uses a solvent method to adhere the adhesive layer 20, which is safe and toxic free, and has an excellent weatherability and a high viscosity, on the EVA block body 10 as a membrane. The solvent method uses a highly volatile solvent to spread the highly sticky adhesive layer 20 and form a solution which is in turn adhered to the EVA building block 10. The solution is vaporized to form a membrane. The volatile solvent is aliphatic hydrocarbon group n-hexane which is good in spreading to both PIB and butyl rubber. Aliphatic hydrocarbon group solvent has an excellent spread to PIB. This is because PIB is a saturated hydrocarbon polymer. Butyl rubber is not as good as PIB in terms of spread. Spread capability of the mixture is increased due to the mixing of butyl rubber and PIB. After being vaporized, a highly viscous membrane is adhered to the EVA block body 10. Further, two EVA block bodies 10 can be adhered together or separated. The two separated EVA block bodies 10 can be adhered together again. No glue is left on the hand after the hand touches the sticky membrane. This means that there is a strong adhesion force between the sticky membrane and the EVA. This is because the completely spread, sticky high polymer adhesive layer 20 solution can impregnate EVA surface. After vaporization, the sticky membrane can hold a plurality of holes 11 of the EVA block body 10 due to the mixing of PIB and EVA. As a result, they form a whole.

Finally, a number of the EVA block bodies 10 are put in the solution. Next, the EVA block bodies 10 are taken out and wait until the solvent completely vaporizes. A product of the invention is produced. The product includes many EVA block bodies 10 sticky together. Its appearance is like a number of building blocks stacked together. Shape of the product can be changed by the hand. Alternatively, one EVA block body 10 is stacked on another EVA block body 10 and so on until a desired shape is formed. No glue is left on the hand. This a toy having the features of both clay and building block.

The invention has the following advantages and benefits in comparison with the conventional art:

A building block assembly is provided with a block body formed of EVA and an adhesive layer adhered to the block body and formed of hydrophobic material having a higher viscosity.

A building block assembly is provided which forms a building block without tenon. A high viscosity, high polymer block body is used on a building block. Next, size of EVA block body is changed. As a result, a toy having the properties of building block and clay is generated.

A building block assembly is provided and the building block assembly can be squeezed, pressed, assembled, adhered so that a kid has a great fun by working on it.

A building block assembly is provided and the building block assembly can have any color or be colorful. The building block assembly can be any shape such as cube, parallelepiped, circle, or triangle. Length, width and height of the building block assembly can any sizes.

While the invention has been described in terms of preferred embodiments, those skilled in the art will recognize that the invention can be practiced with modifications within the spirit and scope of the appended claims.

What is claimed is:

1. A building block assembly comprising:
a block body formed of ethylene vinyl acetate (EVA); and
an adhesive layer adhered to the block body and formed of hydrophobic material having a higher viscosity wherein the adhesive layer comprises 20 wt %-50 wt % of rubber mixture and 50 wt %-80 wt % of high polymer resin mixed together; wherein the rubber mixture comprises rubber, softening agent and filler; and wherein the high polymer resin uses polyisobutylene (PIB) having a heavy molecular weight.

2. The building block assembly of claim 1, wherein the rubber has 30 wt %-50 wt % of butyl rubber; the softening agent has 15 wt %-40 wt % of polybutene (PB) having a light molecular weight; and the filler has 30 wt %-50 wt % of the rubber mixture; and
wherein silicon dioxide (SiO₂), aluminium hydroxide (Al(OH)₃), calcium carbonate (CaCO₃), or a combination thereof is selected as the filler.

3. A building block assembly comprising:
a block body formed of soft material; and
an adhesive layer adhered to the block body and formed of hydrophobic material having a higher viscosity wherein the adhesive layer comprises 20 wt %-50 wt % of rubber mixture and 50 wt %-80 wt % of high polymer resin mixed together; wherein the rubber mixture comprises rubber, softening agent and filler; and wherein the high polymer resin uses polyisobutylene (PIB) having a heavy molecular weight.

4. The building block assembly of claim 3, wherein the rubber has 30 wt %-50 wt % of butyl rubber; the softening agent has 15 wt %-40 wt % of polybutene (PB) having a light molecular weight; and the filler has 30 wt %-50 wt % of the rubber mixture; and wherein silicon dioxide (SiO₂), aluminium hydroxide (Al(OH)₃), calcium carbonate (CaCO₃), or a combination thereof is selected as the filler.
